(19) United States
(12) Patent Application Publication
(10) Pub. No.: US 2021/0147580 A1
(43) Pub. Date: May 20, 2021

(54) COMPOUND, METHOD OF PRODUCTION AND USES THEREOF

(71) Applicants: UNIVERSIDADE NOVA DE LISBOA, Caparica (PT); INST1TUTO SUPERIOR DE AGRONOM1A - UNIVERSIDADE DE LISBOA, Lisboa (PT)

(72) Inventors: Luisa Maria DA SILVA PINTO FERREIRA, Caparica (PT); Ricardo Alexandre VENTURA DAS CHAGAS, Caparica (PT); Ricardo BOAViDA FERREIRA, Lisboa (PT); Isabei Maria RÔLA COELHOSO, Caparica (PT); Svetiozar GUEQRGUIEV VELiZAROV, Caparica (PT)

(21) Appl. No.: 17/047,313

(22) PCT Filed: Apr. 16, 2018
(86) PCT No.: PCT/IB2018/052632

§ 371 Date: Oct. 13, 2020

(30) Foreign Application Priority Data
Apr. 13, 2018 (PT) 110682

(51) Int. Cl. C08B 15/00; B01D 39/18

(52) U.S. Cl. CPC C08B 15/005; B01D 39/18

(57) ABSTRACT

The present disclosure relates to a compound, in particular it relates to a polymer that may be used in the field of protein removal from aqueous solutions, in particular from wines. Furthermore, the present disclosure also relates to a method of production of said compound and to uses thereof.

### TECHNICAL FIELD

The present disclosure relates to a compound, method of production and uses thereof, in particular a polymer that may be used in the field of protein removal from aqueous solutions, in particular from wines.

### BACKGROUND

Until now, the most effective way to remove proteins from white wines consists in the use of bentonite, a negatively charged clay that can remove positively charged molecules (including proteins) from wines. Although effective, this procedure produces large quantities of lees (i.e. precipitates in the bottom of the tanks), removes desirable aroma compounds and produces undesirable by-products (i.e. difficult to treat by-products that cannot be sent to water treatment stations). It was estimated that approximately 6361 tons of bentonite are used, per year, considering just the European wine industry. The same study also shows that bentonite fining has an estimated annual cost of U.S. $1 billion to the world wine industry [1].

Bentonite has the following disadvantages: high lees production (wine waste), it is non-regenerable, difficult to dispose (landfill) and has a negative organoleptic impact on wine.

Filters developed by Pall Company that introduced bentonite into hollow-fibers filters for the stabilization of wines in an in-line system pretend to reduce the wine losses in lees. It is a quick method for the simultaneous finning and filtration. However, this technology is expensive, needs specific bentonite granulometry to work and has all the disadvantages of using bentonite described above.

One technology based in proteases developed by Australian researchers, Proctase, is waiting for OIV approval, but has already been approved in AUS by FSANZ. Proctase is a mixture of Aspergilopepsins I and II used to “degrade” proteins at low pH. In the case of wine, Proctase is used together with heat treatment to unfold wine proteins, increasing the efficiency of the proteases. Its use was authorized in Australia and New Zeeland but not yet in Europe, which is a significant disadvantage. Proctase also has the following disadvantages: the wine must be heated to 70° C., and the enzyme remains in the wine.

Some other technologies based on zirconium dioxide [2, 3, 4] and carrageenan [5] were described but were not commercialized.

These facts are disclosed in order to illustrate the technical problem addressed by the present disclosure.

### GENERAL DESCRIPTION

This disclosure relates to the removal of positively charged compounds/molecules, in particular proteins, from the aqueous matrix at a pH≥2.5-3.5, wherein the removal is carried out by cation exchange. The removed compounds/molecules comprise positively charged wine proteins that, once the wine is bottled without removal of the latter, can aggregate and precipitate induced by thermal denaturation. The precipitation of these proteins will produce a haze (called protein haze) which can cause the consumer to reject that wine.

The aim of the present disclosure is to remove for example unstable positively charged proteins from white wines promptly by cation exchange at low pH (≥2.5-3.5) and also organic and inorganic salts or proteins in other matrixes, among other positively charged compounds. An advantage of this disclosure is that with the removal of these proteins, wines, in particular white wines but also rose and red wines, will be protein stable and less prone to produce precipitates after bottling, a defect commonly known as protein haze.

Furthermore, even better results are obtained with the present disclosure versus the already known systems because the compound/polymer now disclosed, in particular the cross-linking of the cellulose derivative, avoids its solubilization in a water/ethanol medium, in particular wine. Thus, the ion-exchanger now disclosed, cross-linked dicarboxymethylcellulose (CL-DCMC), is insoluble in a water/ethanol medium, in particular wine.

Moreover, even better results are obtained with the compound/polymer now disclosed as this compound/polymer allows the filtration of a liquid, in particular wine, without the need to use high pressure to filter the wine nor it remains in the wine after filtration. As such, this compound/polymer has significant advantages over the prior art and furthermore does not lead to changes in the organoleptic properties of filtered liquid, in particular wine.

This compound/polymer has the capacity to perform cation exchange when protonated or in its salt form namely in the sodium, potassium, calcium or magnesium salt form.

In contrast to other cellulose ether derivatives (e.g. carboxymethyl cellulose), the pKa of the DCMC polymer is low, approx. 2.2, what makes it suitable to perform ion exchange at low pH, in particular at 2.5-3.5 due to its ability to stay deprotonated at that pH. This allows to use this polymer to remove positively charged molecules from the medium by cation exchange.

The compound/polymer can be regenerated i.e. remove the adsorbed molecules from the matrix washing the compound/polymer with a high ionic strength solution e.g. 1 M NaCl or 1 M KCl or with a strong acid solution (e.g. 1 M H₂SO₄ or 1 M HCl) or with weak bases (e.g. 1 M NaHCO₃, Na₂CO₂, KHCO₃, K₂CO₃).

When cross-linked, this compound/polymer is insoluble in aqueous media but retains its ability to perform cation exchange. This characteristic allows the removal of positively charged proteins from a buffer, in particular both when used as film, membrane, or in powder.

Furthermore, this compound/polymer now disclosed can be used in-line with technologies already used in wineries (e.g. in-line plate and frame filters prior to bottling); uses a biodegradable source material (cellulose based polymer); easy to dispose after usage (e.g. recycling, compost).

Furthermore, this compound/polymer now disclosed can be used to remove some undesirable biogenic amines comprising ochratoxin A, tyramine, putrescine and histamine from wine.

Thus, the object of this disclosure is to provide a compound/polymer capable of removing positively charged molecules, in particular proteins, from an aqueous matrix, in particular wine, at a pH 2.5-3.5, without the need to use high pressure filtration step to filter said aqueous matrix, therefore the compound/polymer does not remain in the aqueous matrix nor does it significantly change the aqueous matrix properties, in particular the organoleptic properties of filtered wine. The object of this disclosure is achieved with the compound/polymer now disclosed.

In the present disclosure compound/polymer and cross-linked dicarboxymethylcellulose (CL-DCMC) are synonyms.

The present disclosure relates to compound of formula I,

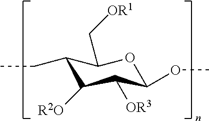

wherein
n, R¹, R², R³ are independently selected from each other;
n is an integer from 20-5000;
R¹, R², R³ are selected from H, Na, K, Ca, Mg, CH(COOH)₂, CH(COONa)₂, CH(COOK)₂, CH(COO)₂Ca, CH(COO)₂Mg or A
wherein A is

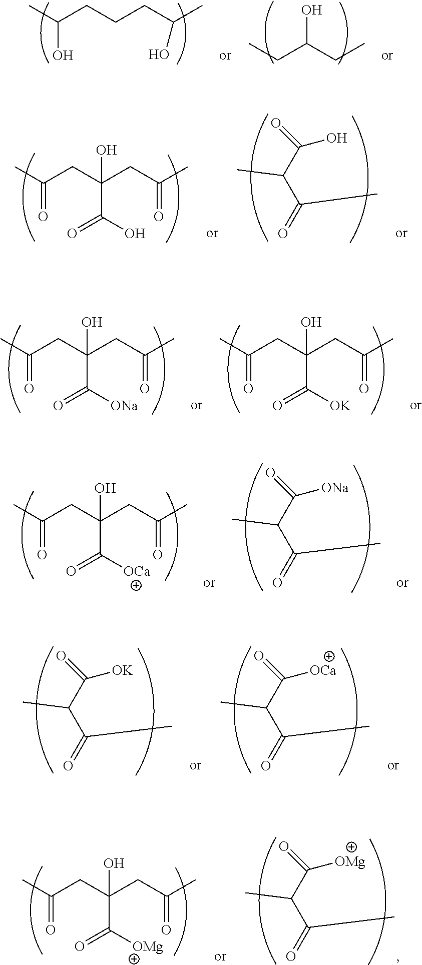

and
wherein the degree of substitution is at least 0.1;
provided that at least one R¹ or R² or R³ is A, wherein the compound is covalently cross linkable, preferably cross-linked, in particular a first compound of formula I is covalently cross-linked to a second compound of formula I via A.

In an embodiment, n may be from 50-3500, preferably n from 100-2000, more preferably from 200-400.

In the present disclosure n is the degree of polymerization and is understood as the cellulose chain length expressed as the average number of anhydroglucose units.

In an embodiment, and in order to obtain better results the compound may have a degree of substitution of less than 3, preferably the degree of substitution is between 0.5-2, more preferably the degree of substitution is between 0.75-1.

In the present disclosure the degree of substitution (DS) is understood as the average number of substituent groups attached per anhydroglucose unit.

In an embodiment, the compound may have a degree of cross-linking (Dcl) is between 0.1-1, preferably 0.15-0.5.

In the present disclosure, the degree of cross-linking is understood as the average number of anhydroglucose units covalently linked to an anhydroglucose unit of other polymer chains.

In an embodiment, the compound has a pKa of its conjugated acid of at most 2.6, preferably of 2.0-2.5.

In an embodiment, R¹, R², R³ are independently selected from Na, CH(COONa)₂ or A, wherein A is

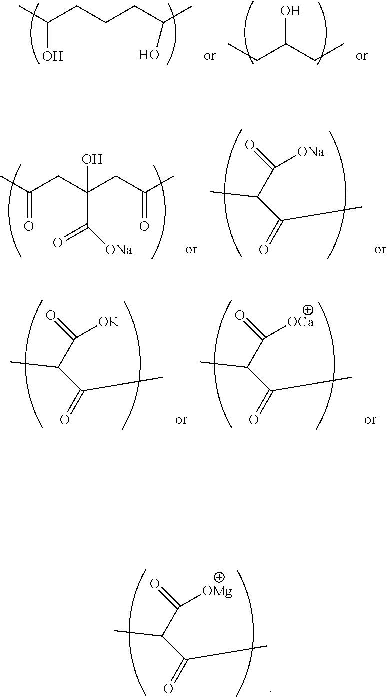

In an embodiment, to obtain better results, A may be

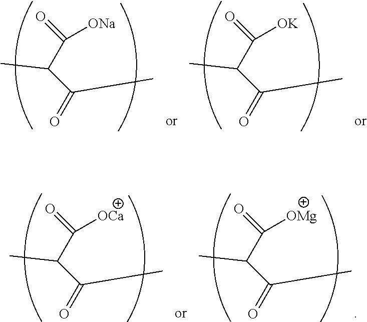

In an embodiment, and to obtain even better results, A may be

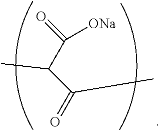

In an embodiment, the compound may be a water-insoluble compound.

In an embodiment, the compound may be a covalently cross-linked dicarboxymethylcellulose.

In an embodiment, the compound may have a molecular weight of at least 7000 g/mol, preferably 9500-2500000 g/mol, more preferably 10000-190000 g/mol.

In an embodiment, the compound may be

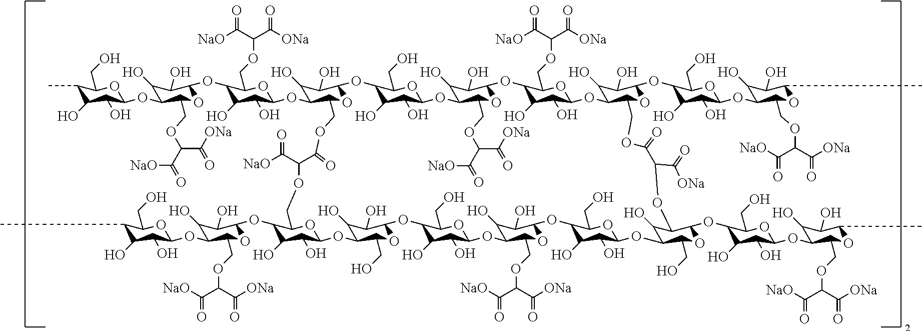

wherein the degree of polymerization is 20, the degree of substitution is 0.5, and the degree of cross-linking is 0.2.

In an embodiment, the compound may be a polymer, in particular the polymer is in the form of a film, or a powder, or a membrane.

In the present disclosure, a film is understood as film produced by the dissolution of dicarboxymethylcellulose in water followed by the evaporation of the added water. After evaporation, it forms a film totally constituted by DCMC. This film is cross-linked to obtain the compound disclosed in this invention. Also, in the present disclosure, a powder is understood as the dried compound disclosed in the present disclosure mechanically ground to a powder, while a membrane is understood as a porous membrane where CL-DCMC is mixed with cellulose at a concentration between 5 to 50% (w/w) prior to membrane formation. The resulting filter membrane comprises cellulose mixed with the compound disclosed in this invention in a determined ratio that is able not only to filter the liquid being treated but also to perform ion exchange.

The present disclosure also relates to a film comprising the compound now disclosed, or to a powder comprising the compound now disclosed or to a membrane comprising the compound now disclosed.

This disclosure also relates to a cellulosic membrane comprising the compound now disclosed, or to an adsorbent material comprising the compound now disclosed.

Furthermore, this disclosure also relates to a filtration apparatus comprising the film, or the cellulosic membrane, or the adsorbent material, or the powder now disclosed.

The present disclosure also relates to the use of the compound now disclosed as an ion-exchanger, or as a protein remover from liquid, preferably wherein the liquid is wine.

This disclosure further relates to a process for producing the compound of formula I, comprising the following step:

submitting the compound of formula II,

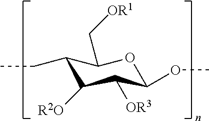

wherein
n, R¹, R² and R³ are independently selected from each other,
n is an integer from 20-5000,
R¹, R², R³ are selected from H, Na, K, Ca, Mg, CH(COOH)₂, CH(COONa)₂, CH(COOK)₂, CH(COO)₂Ca, CH(COO)₂Mg, and at least one R¹ or R² or R³ is CH(COOH)₂, CH(COONa)₂, CH(COOK)₂, CH(COO)₂Ca, CH(COO)₂Mg;
to a cross-link treatment carried out with heat or with epichlorohydrin, epibromohydrin, epiiodohydrin, glutaraldehyde or citric acid.

In an embodiment and for even better results, the cross-linking treatment is carried out by heat treatment.

In an embodiment, the temperature is at least 100° C., preferably 105° C.

In an embodiment, the temperature is at least 100° C., preferably 100-120° C., more preferably 105°, for at least 30 minutes, preferably 1 hour-3 hours, more preferably 2 hours.

### BRIEF DESCRIPTION OF THE DRAWINGS

For an easier understanding of the disclosure, attached there are figures which represent preferred embodiments of the disclosure that, however are not intended to limit the scope of protection of the present disclosure.

FIG. 1—A) Experimental adsorption isotherm for cytochrome c (1 mg/mL) on CL-DCMC powder in 25 mM citrate buffer, pH 3.2, for 30 minutes. The line represents the nonlinear fitting using the Langmuir model equation; B) Linear fitting of the experimental values presented in A based on the Langmuir model (R²=0.998).

FIG. 2—A) Experimental adsorption isotherm for isolated wine protein at 1 mg/mL, for 30 minutes, on CL-DCMC in model wine solution (5 g/L tartaric acid, 12% v/v ethanol, pH 3.2). B) Linear fitting of the experimental values presented in A based on the Langmuir model (R²=0.982).

FIG. 3—FTIR-ATR spectra of Avicel PH101 (- -), dicarboxymethylcellulose sodium salt DCMC Na (-), and cross-linked deprotonated dicarboxymethylcellulose (sodium salt) CL-DCMC Na (-⋅-).

FIG. 4—Cellulosic membrane/filter with CL-DCMC added at a concentration of 18% (w/w). The spots scattered along the sheet correspond to the added CL-DCMC.

FIG. 5—Representation of the CL-DCMC/cellulose mixed membranes after filtration of cytochrome c solution and washing with deionized water.

### DETAILED DESCRIPTION

The present disclosure relates the cross-linked dicarboxymethylcellulose ether (CL-DCMC), method of production and uses thereof.

In an embodiment, the method comprises in activating cotton, wood cellulose with lignocellulose or crystalline cellulose with a 12% to 50% (w/v) NaOH solution and an organic solvent. After activation, the sodium, potassium, magnesium or calcium salt of a halogenated malonic acid is added to the reaction mixture at the appropriate temperature range and under the stirring state. After adjusting the reaction mixture to the appropriate temperature, the cellulose is subjected to etherification reaction. After the appropriate amount of time, the product dicarboxymethylcellulose ether with a degree of substitution of at least 0.1, is obtained through the processes of neutralization, washing, and drying.

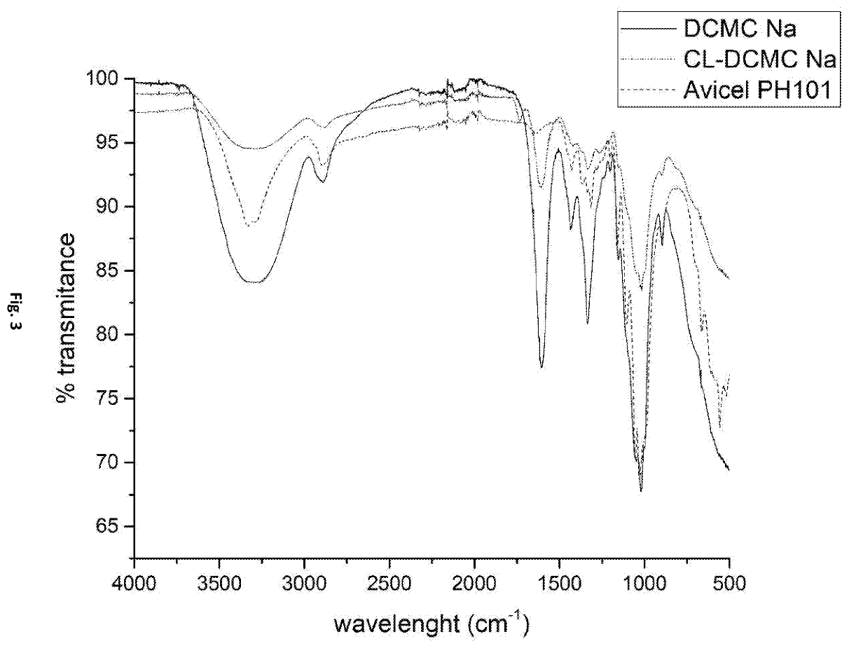

Synthesis of dicarboxymethylcellulose is performed in a heterogeneous liquid-solid reaction in an organic/water mixture. Addition of alkali and etherifying agent allows the etherification reaction process with controlled temperature and agitation. After etherification, dicarboxymethylcellulose is protonated, and heat treated to achieve a cross-linked ester capable of performing ion exchange while being insoluble in water-based solutions or beverages (comprising wine, beer, fruit juice and alike). Both reactions (etherification and cross-linking) can be monitored by the variation of the carbonyl bands between 1650 and 1700 cm⁻¹ in a FTIR spectrum (FIG. 3).

In an embodiment, at a temperature of 10 to 30° C., 100 g of cellulose is added to 1000 to 2000 mL of appropriate organic solvent, in particular e.g. isopropanol, 1-propanol, methanol, ethanol, to which an appropriate amount of NaOH aqueous solution is added, e.g. 15 to 40% w/v. The cellulose is activated in the alkali solution for 1 to 2 hours at 25° C. An aqueous solution of the sodium salt of the halogenated malonic acid or corresponding acid forms, which comprises the sodium, potassium, calcium or magnesium salts of iodomalonate, bromomalonate or chloromalonate, is added dropwise to the reaction mixture producing an overall water final concentration of 8 to 12% (v/v). A catalyst such as potassium iodide or sodium iodide can be added at this stage to increase the reaction rate. Etherification process is achieved by raising the temperature to between 55 and 75° C. and maintaining that temperature for 3 to 5 hours with continuous agitation. After completion, the product is filtered from solution, suspended in 70% (v/v) alcoholic solution, e.g. isopropanol, methanol or ethanol, and the pH adjusted to 5 using glacial acetic acid. The mixture is filtered, washed an adequate number of times with 70% (v/v) alcoholic solution and the precipitate is dried under vacuum at adequate temperature (e.g. 20 to 60° C.). After etherification, the compound/polymer is protonated suspending it in a 10 to 20% (w/v) strong acid solution (e.g. sulfuric acid, hydrochloric acid or alike). The resulting compound is precipitated by addition of an alcohol (e.g. methanol, isopropanol, ethanol) to a final concentration of 70% (v/v) and then centrifuged to remove the supernatant to yield a powder. The solid is washed with a hydro-alcoholic solution the adequate amount of times to remove residual acid and then dried under vacuum at adequate temperature (e.g. 20 to 60° C.). The resulting dried compound is then heat treated in an oven at a temperature of 100 to 120° C. for 1 to 3 hours to achieve the esterification and cross-linking of the compound/polymer by dehydration. The compound obtained after etherification can also be covalently cross-linked using other cross-linking agents comprising glutaraldehyde, epichlorohydrin, epibromohydrin, epiiodohydrin or citric acid. The resulting cross-linked product is then deprotonated using an adequate alkali agent, e.g. sodium hydrogen carbonate, sodium bicarbonate, potassium hydrogen carbonate, potassium bicarbonate, sodium hydroxide, potassium hydroxide or alike, and washed with water to remove residual alkali agent.

In an embodiment, the process for producing the CL-DCMC now disclosed, comprises the following steps: following protonation of the DCMC by a strong acid, this is thoroughly dried and allowed to esterify in an oven with controlled temperature between 100 and 120° C. The resulting cross-linked compound/polymer is further deprotonated using a weak base to form the salt of the CL-DCMC.

In an embodiment, the preparation of heat cross-linked sodium dicarboxymethylcellulose can be expressed by the following chemical reaction equations:

Alkalization of Cellulose to Alkali Cellulose:

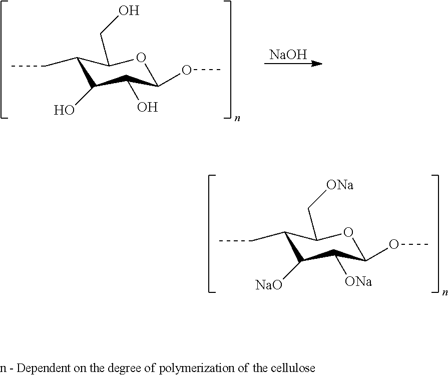

Conversion of Bromomalonic Acid to Sodium Bromomalonate:

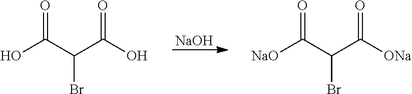

Etherification of Deprotonated Cellulose with Sodium Bromomalonate:

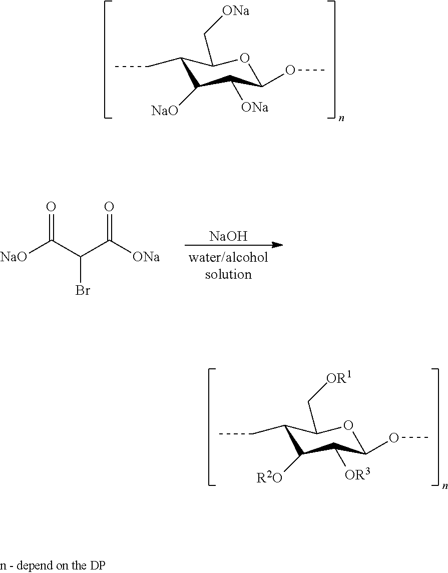

wherein R¹, R², R³ are selected from H, Na, CH(COOH)₂, CH(COONa)₂,
and the degree of substitution is at least 0.1;

Protonation of the Previous Compound and Cross-Linking by Esterification Using Heat Dehydration.

In an embodiment, the representation of the compound cross-linking process by esterification (by heat dehydration) can be as follows:

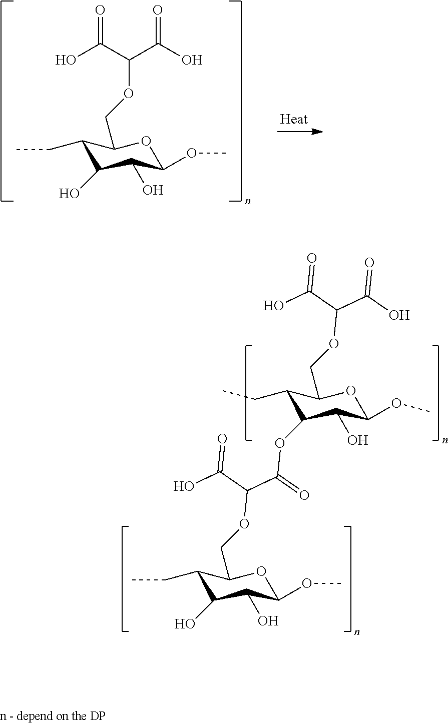

In an embodiment, the preparation of sodium dicarboxymethylcellulose, potassium dicarboxymethylcellulose, calcium dicarboxymethylcellulose or magnesium dicarboxymethylcellulose, can be expressed as above-mentioned for the synthesis of sodium dicarboxymethylcellulose using sodium bromomalonate with the proper changed associated to different halogenated salts (sodium bromomalonate, potassium bromomalonate, calcium bromomalonate, magnesium bromomalonate, sodium chloromalonate, potassium chloromalonate, calcium chloromalonate, magnesium chloromalonate, sodium iodomalonate, potassium iodomalonate, calcium iodomalonate and magnesium iodomalonate).

In an embodiment, the preparation of heat cross-linked calcium dicarboxymethylcellulose or heat cross-linked potassium dicarboxymethylcellulose or heat cross-linked magnesium dicarboxymethylcellulose, can be expressed as above-mentioned for heat cross-linked sodium dicarboxymethylcellulose with the proper changes associated to a different salt (either calcium salt, potassium salt or magnesium salt).

In an embodiment, the etherification reaction occurs in alkaline media and in the presence of water. Due to that, this reaction will present some side reactions such as the production of sodium hydroxymalonate, hydroxymalonic acid, the corresponding salts from the reacted halogen (e.g. KBr, NaBr, KI, NaI, KCl, NaCl or alike) and unreacted starting material.

In an embodiment, in the preparation of dicarboxymethylcellulose ether, several parameters may need to be controlled to avoid the excess formation of these by-products and promote the consumption of all alkali and etherifying agent.

Excessive production of these by-products and salt impurities cause difficulties in the purification of the final product and affect the properties of it. Increases in salt concentration or changes in pH will have a great impact, for example, in the viscosity of the produced polymer (prior to cross-linking) when dissolved in water or in the calculus of its degree of substitution. The degree of side reactions is primarily related to the amount of free base in the system, which is related to the amount of excess alkali that is not associated with cellulose-forming alkali cellulose. The higher the amount of free base, the stronger the side reactions. The reaction should promote the cellulose deprotonation and the formation of the corresponding alkoxide, but the excessive free base can not only lead to the hydrolysis of the alkali cellulose but also increased production of by-products. As a result, it is necessary to adjust the alkali and water concentrations to assure the deprotonation of the cellulose but, at the same time optimize the conditions to assure a better etherification reaction without the production of excessive by-products.

Stirring speed and type of stirring also may have an impact on the final product. These must be adjusted to increase the contact between the alkali and the cellulose that is suspended in the organic solvent. To avoid clumping of the reaction mixture, mechanical agitation is preferred compared to others. Also, the speed of agitation has to be controlled since the incorporation of excessive oxygen in the reaction in alkaline media can also promote the degradation of the cellulose chain and decrease its degree of polymerization.

The temperature has also an effect on the etherification efficiency. To improve etherification efficiency, one may perform the addition of the different reagents at controlled temperature and avoid temperatures above 90° C. to avoid not only cellulose degradation but also decarboxylation of the substituent.

The organic solvent used in the reaction can be any one of isopropanol, n-propanol, n-butanol, isobutanol, t-butanol, ethanol, aqueous solutions of the latter solvents or mixtures of these same solvents. The efficiency of the reaction is directly related to the solvent used in the reaction mixture with a preference for branched alcohols that are less reactive to produce other by-products.

The etherification agent can be sodium bromomalonate, sodium iodomalonate, sodium chloromalonate or the same reagents with different counter ions, e.g. potassium, calcium or magnesium. The alkali agent can be any one of sodium hydroxide and potassium hydroxide or a mixture thereof. As a catalyst, metal halides such as sodium iodide or potassium iodide can be used to increase the reaction efficiency at 0.1 to 0.25 equivalents related to the anhydroglucose unit (AGU) content.

### Example 1—Production of CL-DCMC, in Particular Sodium DCMC, by Catalysed Etherification and Cross-Linking by Heat Treatment

In an embodiment the production of CL-DCMC, in particular sodium DCMC by catalysed etherification and cross-linking by heat treatment was carried out as follows. In an open reactor at 25° C., 50 g of Avicel PH101 were suspended in 1760 mL of isopropanol. After full suspension of the starting material, 92 mL of 40% (w/v) NaOH were added dropwise for 30 minutes. The alkalization of the cellulose occurs for 1 to 2 hours at a temperature not superior to 30° C. Then, 174 g of sodium bromomalonic acid were added to the reaction mixture dissolved in the adequate amount of water making a final water concentration of 12% (v/v) together with 3 g of potassium iodide. The temperature of the reactor was raised to 70° C. and the reaction was kept for 3 hours. After reaction completion, the precipitate was filtered, washed with 70% (v/v) methanol solution and neutralized with glacial acetic acid. The product was washed with 100% (v/v) methanol and then dried in vacuum at room temperature. The product was protonated suspending the compound/polymer in 20% (w/v) sulfuric acid at 5° C. for 1 hour. The product was precipitated adding methanol to a final concentration of 70% (v/v) and the reaction mixture was centrifuged. The precipitate was thoroughly washed with water and methanol to remove residual acid or salts. After drying the product in vacuum, it was cross-linked at 105° C. for 2 hours in an oven. The final cross-linked compound/polymer was then deprotonated suspending it in a sodium bicarbonate solution overnight, filtered and washed thoroughly with deionized water to remove residual salts.

### Example 2—Production of CL-DCMC, in Particular Sodium DCMC, by Basic Etherification and Cross-Linking by Heat Treatment

In an embodiment, the production of CL-DCMC, in particular sodium DCMC, by basic etherification and cross-linking by heat treatment was carried out as follows. In an open reactor at 25° C., 100 g of Avicel PH101 were suspended in 3500 mL of isopropanol/methanol solution. After full suspension of the starting material, 184 mL of 40% (w/v) NaOH were added dropwise for 30 minutes. The alkalization of the cellulose occurs for 1 to 2 hours at a temperature not superior to 30° C. Then, 348 g of sodium chloromalonic acid were added to the reaction mixture dissolved in the adequate amount of water making a final water concentration of 11% (v/v). The temperature of the reactor was raised to 55° C. and the reaction was kept for 5 hours. After reaction completion, the precipitate was filtered, washed with 70% (v/v) ethanol solution and neutralized with glacial acetic acid. The product was washed with ethanol and then dried in vacuum at room temperature. The product was protonated suspending the compound/polymer in 20% (w/v) sulfuric acid at 5° C. for 1 hour. The product was precipitated adding methanol to a final concentration of 70% (v/v) and the reaction mixture was centrifuged. The precipitate was thoroughly washed with water and methanol to remove residual acid or salts. After drying the product in vacuum, it was cross-linked at 110° C. for 1 hours in an oven. The final cross-linked compound/polymer was then deprotonated by suspending it in a sodium bicarbonate solution overnight, filtered and washed thoroughly with deionized water to remove residual salts.

### Example 3—Production of CL-DCMC, in Particular Sodium DCMC, by Catalysed Etherification, Protonation by HCl Gas and Cross-Linking by Heat Treatment

In an embodiment, the production of CL-DCMC, in particular sodium DCMC, by catalysed etherification, protonation by HCl gas and cross-linking by heat treatment was carried out as follows. In an open reactor at 25° C., 50 g of Avicel PH101 were suspended in 1760 mL of isopropanol. After full suspension of the starting material, 92 mL of 40% (w/v) NaOH were added dropwise for 30 minutes. The alkalization of the cellulose occurs for 1 to 2 hours at a temperature not superior to 30° C. Then, 174 g of sodium bromomalonic acid were added to the reaction mixture dissolved in the adequate amount of water making a final water concentration of 12% (v/v) together with 3 g of potassium iodide. The temperature of the reactor was raised to 70° C. and the reaction was kept for 3 hours. After reaction completion, the precipitate was filtered, washed with 70% (v/v) methanol solution and neutralized with glacial acetic acid. The product was washed with 100% (v/v) methanol and then dried in vacuum at room temperature. The product was protonated by passing HCl gas through the dried sample for 10 to 30 minutes. After removing residual HCl from the product by vacuum, this was cross-linked at 105° C. for 2 hours in an oven. The final cross-linked compound/polymer was then deprotonated by suspending it in a sodium bicarbonate solution overnight, filtered and washed thoroughly with deionized water to remove residual salts.

### Example 4—Production of CL-DCMC, in Particular Sodium DCMC, by Basic Etherification and Cross-Linking by Heat Treatment and Incorporation in Cellulosic Membranes

In an embodiment, the production of CL-DCMC, in particular sodium DCMC, by basic etherification and cross-linking by heat treatment and incorporation in cellulosic membranes was carried out as follows. In an open reactor at 25° C., 100 g of Avicel PH101 were suspended in 3500 mL of isopropanol/methanol solution. After full suspension of the starting material, 184 mL of 40% (w/v) NaOH were added dropwise for 30 minutes. The alkalization of the cellulose occurs for 1 to 2 hours at a temperature not superior to 30° C. Then, 348 g of sodium chloromalonic acid were added to the reaction mixture dissolved in the adequate amount of water making a final water concentration of 11% (v/v). The temperature of the reactor was raised to 55° C. and the reaction was kept for 5 hours. After reaction completion, the precipitate was filtered, washed with 70% (v/v) ethanol solution and neutralized with glacial acetic acid. The product was washed with ethanol and then dried in vacuum at room temperature. The product was protonated suspending the compound/polymer in 20% (w/v) sulfuric acid at 5° C. for 1 hour. The product was precipitated adding methanol to a final concentration of 70% (v/v) and the reaction mixture was centrifuged. The precipitate was thoroughly washed with water and methanol to remove residual acid or salts. After drying the product in vacuum, it was cross-linked at 110° C. for 1 hours in an oven. The final cross-linked compound/polymer was then deprotonated by suspending it in a sodium bicarbonate solution overnight, filtered and washed thoroughly with deionized water to remove residual salts. The deprotonated cross-linked compound/polymer was mixed with purified cellulose at a concentration between 5 and 30% (w/w) and suspended in water. Mixed CL-DCMC/cellulosic membranes were then formed by removing all water by vacuum under a stainless-steel mesh. The resulting sheet is then dried at room temperature followed by drying in an oven at 50° C.

In an embodiment, the production of polymer/cellulosic membranes is possible by incorporation of an adequate amount of CL-DCMC, in particular from 5-50% (w/w), in particular 10-30% (w/w) to cellulose dispersed in water and posterior formation of the membrane by vacuum in a stainless-steel mesh. The resulting membrane maintains the cation exchange properties, in particular at a determined extension depending on the polymer content and can be used as a cation-exchange filter, for example a sodium-exchange filter or a potassium-exchange filter or alike.

### Example 5—Production of CL-DCMC, in Particular Sodium DCMC, by Basic Etherification and Cross-Linking by Reaction with Epichlorohydrin

In an embodiment, the production of CL-DCMC, in particular sodium DCMC, by basic etherification and cross-linking by reaction with epichlorohydrin was carried out as follows. In an open reactor at 25° C., 100 g of Avicel PH101 were suspended in 3500 mL of isopropanol/methanol solution. After full suspension of the starting material, 184 mL of 40% (w/v) NaOH were added dropwise for 30 minutes. The alkalization of the cellulose occurs for 1 to 2 hours at a temperature not superior to 30° C. Then, 348 g of sodium chloromalonic acid were added to the reaction mixture dissolved in the adequate amount of water making a final water concentration of 11% (v/v). The temperature of the reactor was raised to 55° C. and the reaction was kept for 5 hours. After reaction completion, the precipitate was filtered, washed with 70% (v/v) ethanol solution and neutralized with glacial acetic acid. The product was washed with ethanol and then dried in vacuum at room temperature. Following drying, the compound/polymer was added to a solution of 2 M NaOH in an inert atmosphere of nitrogen gas and the temperature raised to 80° C. After 3 to 5 hours at 80° C., 1 to 4 moles of epichlorohydrin are added to the reaction mixture (moles of epichlorohydrin regarding the moles of AGU). The resulting mixture is allowed to react between 6 to 12 hours with constant agitation and temperature before neutralization with 1 M HCl. The compound/polymer is precipitated with methanol, washed several times with deionized water, filtered, and the precipitate is dried at room temperature under vacuum. The resulting product can be used as it is or ground to a powder to increase its specific surface area.

### Example 6—Production of CL-DCMC, in Particular Sodium DCMC, by Basic Etherification and Cross-Linking by Heat Treatment and Incorporation in Kraft Pulp Membranes

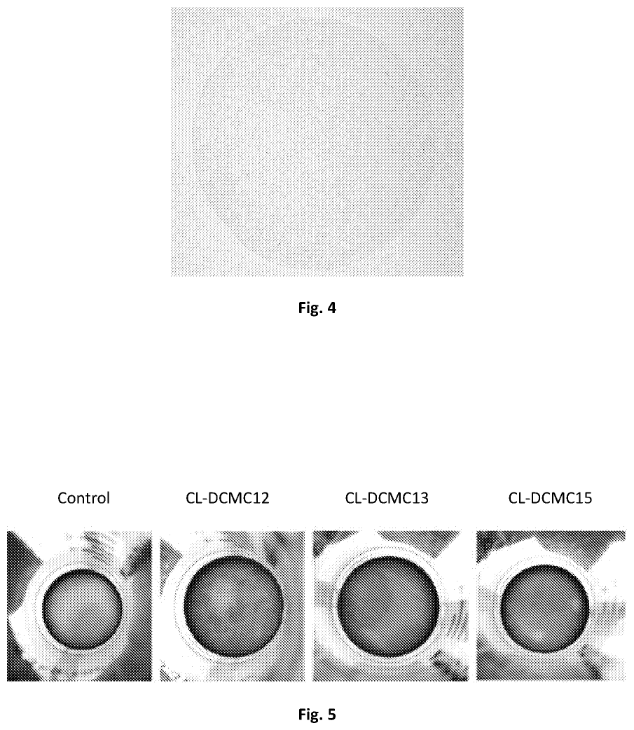

In an embodiment, the production of CL-DCMC, in particular sodium DCMC, by basic etherification and cross-linking by heat treatment and incorporation in kraft pulp membranes. In an open reactor at 25° C., 100 g of Avicel PH101 were suspended in 3500 mL of isopropanol/methanol solution. After full suspension of the starting material, 184 mL of 40% (w/v) NaOH were added dropwise for 30 minutes. The alkalization of the cellulose occurs for 1 to 2 hours at a temperature not superior to 30° C. Then, 348 g of sodium chloromalonic acid were added to the reaction mixture dissolved in the adequate amount of water making a final water concentration of 11% (v/v). The temperature of the reactor was raised to 55° C. and the reaction was kept for 5 hours. After reaction completion, the precipitate was filtered, washed with 70% (v/v) ethanol solution and neutralized with glacial acetic acid. The product was washed with ethanol and then dried in vacuum at room temperature. The product was protonated suspending the compound/polymer in 20% (w/v) sulfuric acid at 5° C. for 1 hour. The product was precipitated adding methanol to a final concentration of 70% (v/v) and the reaction mixture was centrifuged. The precipitate was thoroughly washed with water and methanol to remove residual acid or salts. After drying the product in vacuum, this was cross-linked at 110° C. for 1 hours in an oven. The final cross-linked product was then deprotonated by suspending it in a sodium bicarbonate solution overnight, filtered and washed thoroughly with deionized water to remove residual salts. To produce the filter membranes, the cross-linked compound/polymer was added to paper slurry (i.e. kraft pulp disintegrated in deionized water) and homogenized with a propeller homogenizer. The paper pulp slurry was then processed in a pulp evaluation apparatus to form the membranes. The sheets presented a diameter of 16 cm with a variable weight between 1.2 and 1.4 g depending on the quantity of paper pulp and compound/polymer added to the slurry. An example of a membrane after drying is represented in FIG. 4.

Examples 1-6 were also carried out for potassium CL-DCMC, calcium CL-DCMC or magnesium CL-DCMC with the proper changes associated to different salts (either calcium salt, potassium salt or magnesium salt).

In an embodiment, the sodium content was determined by ICP-AES as follows. A known amount (approx. 5 mg per sample) of sodium dicarboxymethylcellulose was weighed in new vials and suspended in pure nitric acid. The samples were incubated at 60° C. for 1 hour prior to analysis. Sodium was quantified by ICP-AES. After determination of the sodium content by ICP-AES (% Na_{ICP}), the DS was calculated based on the equation presented by Stojanovic et al. [7] for carboxymethyl starch with the corrected mass of the substituent. The DS was calculated from the following equation:

$$D S = \frac{1 \; 62 \times ( \% \frac{Na}{2} / 23 )}{100 - ( 1 \; 47 \times \% \frac{Na}{2} / 23 )} ,$$

wherein:
162 (g/mol)=molecular mass of an anhydroglucose unit of cellulose
147 (g/mol)=net increase in molecular mass of an anhydroglucose unit for each sodium dicarboxymethyl group added.

In an embodiment, the potassium content was determined by ICP-AES as described for the sodium content.

In an embodiment, the calcium content was determined by ICP-AES as it was described for the sodium content.

In an embodiment, the magnesium content was determined by ICP-AES as it was described for the sodium content.

In an embodiment, the degree of substitution of the compound/polymer was determined by determination of sodium content of the deprotonated compound/polymer by ICP.

In an embodiment, the degree of substitution of the compound/polymer was determined by determination of potassium content of the deprotonated compound/polymer by ICP.

In an embodiment, the degree of substitution of the compound/polymer was determined by determination of calcium content of the deprotonated compound/polymer by ICP.

In an embodiment, the degree of substitution of the compound/polymer was determined by determination of magnesium content of the deprotonated compound/polymer by ICP.

In an embodiment, the structure of the compound now disclosed, in particular the structure of a sodium salt of CL-DCMC structure is

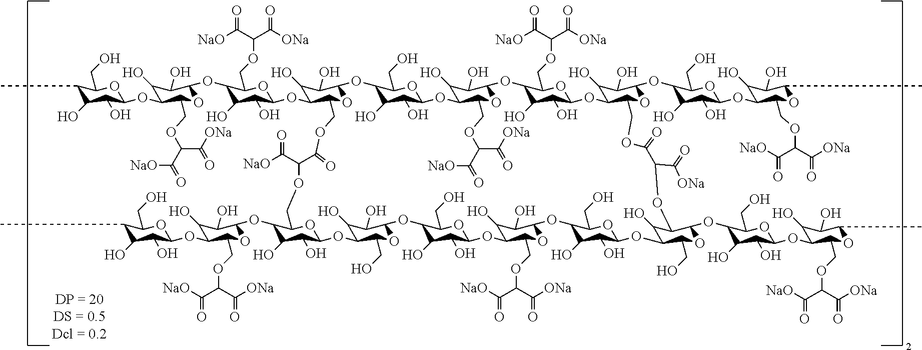

wherein the compound, in particular the sodium salt of DCMC compound has a degree of polymerization of 20 (i.e. 20 anhydroglucose units (AGU) per chain). Taking into consideration one of the cellulose chains consisting of 20 AGU, it is represented 10 dicarboxymethyl groups (i.e. degree of substitution of 0.5) where 4 of these groups are forming an ester bond with the next chain (i.e. degree of cross-linking of 0.2).

In an embodiment, the protein removal capacity was tested as follows. The cross-linked DCMC ability to adsorb positively charged proteins at wine pH, in particular at pH 3.0 to 3.5, was evaluated. Prior to protein adsorption trials using isolated wine protein and tests using a standard model protein were performed. As model protein, cytochrome c from horse heart was chosen. This soluble protein has a molecular weight around 12 kDa, presents positive net charge at acidic pH (pI of 10.5) and a strong resistance to acid since there is evidence that its conformation is stable at pH 1.5 [6].

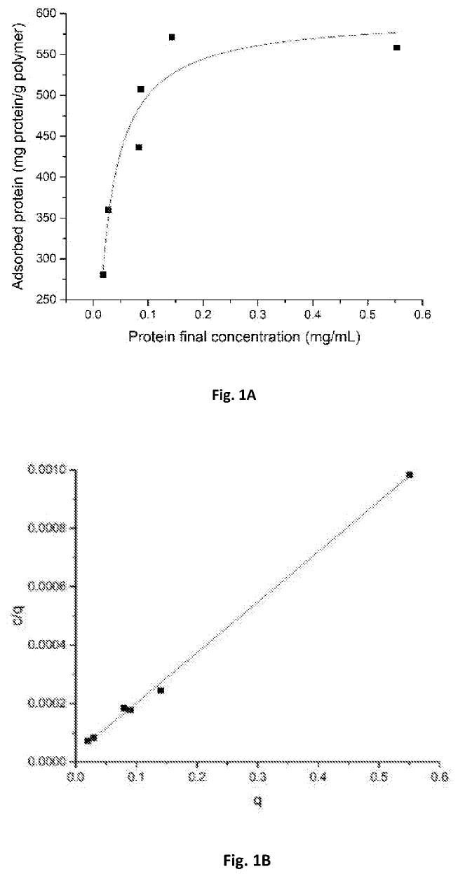

To study the effect of increasing compound/polymer dosages on the adsorption of cytochrome c, an adsorption trial was set up with different amounts of cross-linked DCMC using an initial cytochrome c concentration of 1 mg/mL in 25 mM citrate buffer, pH 3.2 in a 30 minutes trial, at 25° C., with constant agitation. The effect of compound/polymer dosage on the removal of cytochrome c from solution is shown in FIG. 1A.

By the linearization of the Langmuir equation (1B, R²=0.998), values of 588 mg±5 mg protein/g polymer and 56.67 for Qₘₐₓ and Ka respectively were obtained FIG. 1B.

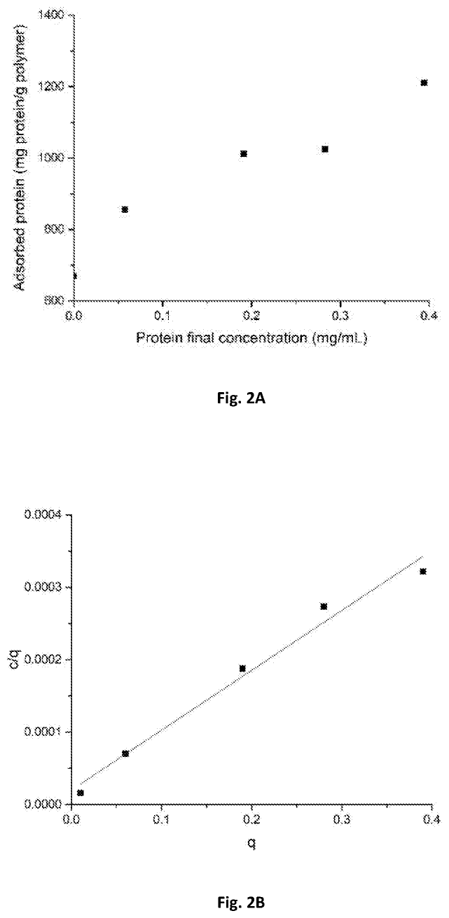

With the protein adsorption capacity of the compound/polymer validated at pH 3.2, it was performed a new experiment with isolated wine protein in model wine solution (5 g/L tartaric acid, 12% v/v ethanol, pH 3.2). Similarly, to the experiment with cytochrome c, the compound now disclosed, in a powder form after deprotonation, was used. To study the effect of increasing compound/polymer dosages on the adsorption of isolated wine protein, an adsorption trial was set up with different amounts of cross-linked DCMC powder using an initial isolated wine protein concentration of 1 mg/mL in model wine solution pH 3.2. The effect of compound/polymer dosage on the removal of isolated wine protein from solution is shown in FIG. 2A.

The results using isolated wine protein were linearized using the Langmuir adsorption isotherm (FIG. 2B, R²=0.982). Analysing the results of the linearization, values of 1250 mg±10 mg protein/g polymer and 26.7 for Qₘₐₓ and Ka, respectively, were obtained.

The used cross-linked compound/polymers in experiments described in FIG. 1 and FIG. 2 have a Na content of 11.3% (w/w) which corresponds to a DS of 0.62.

In an embodiment, the removal of soluble proteins from wine with a cellulosic membrane comprising the cross-linked DCMC was performed. A sample of 10 mL of a Moscatel of Alexandria (2016 vintage) was filtered in an Amicon cell using two 2.6 cm of diameter consecutive sheets of cellulose/cross-linked DCMC membrane. The protein was quantified previous to filtration and after filtration to assess the protein removed by this operation. The results from the filtration operation are described in Table 1. The removal of proteins from wine in conditions similar to the ones found in a winery (direct filtration of the wine with just one flow-through, no buffers, no pH adjustment) showed that this technology can be used to remove soluble proteins from wine and consequently stabilize it. The adsorption of cytochrome c in an analogous experiment is represented in FIG. 5.

The used cross-linked compound/polymers in experiments described in Table 1 have a Na content of 3.4% (w/v) which corresponds to a DS of 0.13.

TABLE 1
Protein adsorption capacity calculation of a cellulose/cross-
linked DCMC membrane after filtering 10 mL of Moscatel of Alexandria
wine. In this trial, two sheets of 2.6 cm of diameter were
used. Protein concentrations were measured directly in the
wine prior and after filtration by the Bradford method.

| | |
|---|---|
| Compound/polymer in membrane (%) | 17.1 |
| Mass of filters (mg) | 90.1 |
| Paper weight (mg/cm²) | 8.1 |
| Usable area in cm² (2 × 2.2 cm [symbol] ) | 7.6 |
| Mass of filter (2 × 2.2 cm [symbol] , mg) | 61 |
| Mass of compound/polymer in filter (mg) | 10.4 |
| Starting protein concentration (mg/L) | 186 |
| Mass of protein in 10 mL sample (mg) | 1.8 |
| Final protein concentration (mg/L) | 86 |
| Adsorbed protein (mg) | 1 |
| Adsorption capacity (mg protein/g polymer | 96.15 |
| or mg protein/g compound) | |

The disclosure should not be seen in any way restricted to the embodiments described and a person with ordinary skills in the art will foresee many possibilities to modifications thereof.

Furthermore, where ranges are given, endpoints are included. Furthermore, it is to be understood that unless otherwise indicated or otherwise evident from the context and/or the understanding of one of ordinary skill in the art, values that are expressed as ranges can assume any specific value within the stated ranges in different embodiments of the invention, to the tenth of the unit of the lower limit of the range, unless the context clearly dictates otherwise. It is also to be understood that unless otherwise indicated or otherwise evident from the context and/or the understanding of one of ordinary skill in the art, values expressed as ranges can assume any subrange within the given range, wherein the endpoints of the subrange are expressed to the same degree of accuracy as the tenth of the unit of the lower limit of the range.

The above described embodiments are combinable. The following claims further set out particular embodiments of the disclosure.

### REFERENCES

[1] P. Majewski, A. Barbalet and E. Waters (2011) $1 billion hidden cost of bentonite fining. Australian & New Zealand Grapegrower & Winemaker No. 569 58-59, 61-62. http://winetitles.com.au/gwm/view/?action=view&id=660.
[2] Marangon, M., Lucchetta, M., and Waters, E. J. (2011) Protein stabilization of white wines using zirconium dioxide enclosed in a metallic cage. Aust. J. Grape Wine Res. 17, 28-35.
[3] Pashova, V., Güell, C., and López, F. (2004) White Wine Continuous Protein Stabilization by Packed Column. J. Agric. Food Chem. 52, 1558-1563.
[4] Pashova, V., Güell, C., and López, F. (2004) White Wine Continuous Protein Stabilization by Packed Column. J. Agric. Food Chem. 52, 1558-1563.
[5] Cabello-Pasini, A., Victoria-Cota, N., Macias-Carranza, V., Hernandez-Garibay, E., and Muñiz-Salazar, R. (2005) Clarification of wines using polysaccharides extracted from seaweeds. Am. J. Enol. Vitic. 56, 52-59.
[6] Coletta, M., Costa, H., De Sanctis, G., Neri, F., Smulevich, G., Turner, D. L., and Santos, H. (1997) pH dependence of structural and functional properties of oxidized cytochrome c from Methylophilus methylotrophus. J. Biol. Chem. 272, 24800-24804.
[7] Stojanovic, Z., Jeremic, K., Jovanovic, S., and Lechner, M. D. (2005). A comparison of some methods for the determination of the degree of substitution of carboxymethyl starch. Starch-Starke, 57, 79-83.

1. A compound of formula I, [symbol]
wherein
n, R², R³ are independently selected from each other;
n is an integer from 20-5000;
R¹, R², R³ are selected from the group consisting of: H, Na, K, Ca, Mg, CH(COOH)₂, CH(COONa)₂, CH(COOK)₂, CH(COO)₂Ca, CH(COO)₂Mg and A,
wherein A is [symbol]
or [symbol]
or 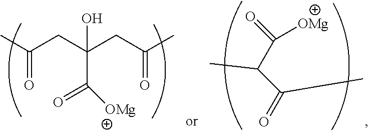
and
the degree of substitution is at from 0.1 to 3;
provided that at least one R¹ or R² or R³ is A, wherein the compound is covalently cross-linked.

2. The compound according to claim 1, wherein a first compound of formula I is covalently cross-linked to a second compound of formula I via A.

3. The compound according to claim 1, wherein n is from 50-3500.

4. (canceled)

5. The compound according to claim 1, wherein the degree of substitution is between 0.5-2.

6. The compound according to claim 1, wherein the degree of cross-linking is between 0.1-1.

7. The compound according to claim 1, wherein the compound has a pKa of its conjugated acid of at most 2.6.

8. The compound according to claim 1, wherein R¹, R², R³ are selected from the group consisting of: Na, CH(COONa)₂ and A, wherein A is

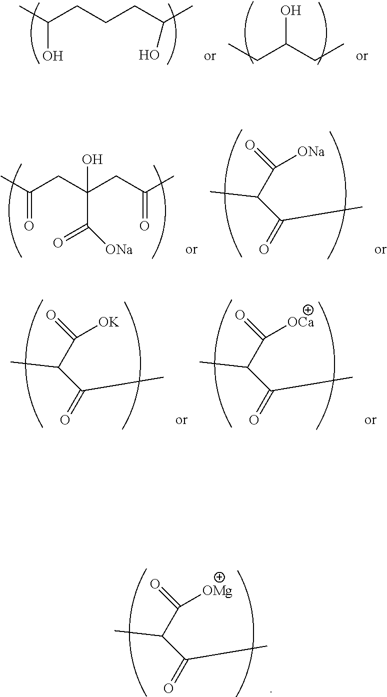

9. The compound according to claim 1, wherein A is

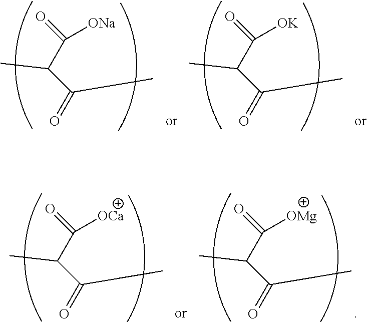

10. The compound according to claim 1, wherein A is

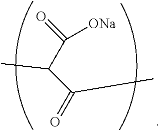

11. The compound according to claim 1, wherein the compound is a water-insoluble compound.

12. The compound according to claim 1, wherein the compound is a covalently cross-linked dicarboxymethylcellulose.

13. The compound according to claim 1, wherein the compound has a molecular weight of at least 7000 g/mol.

14. The compound according to claim 1, wherein the compound is 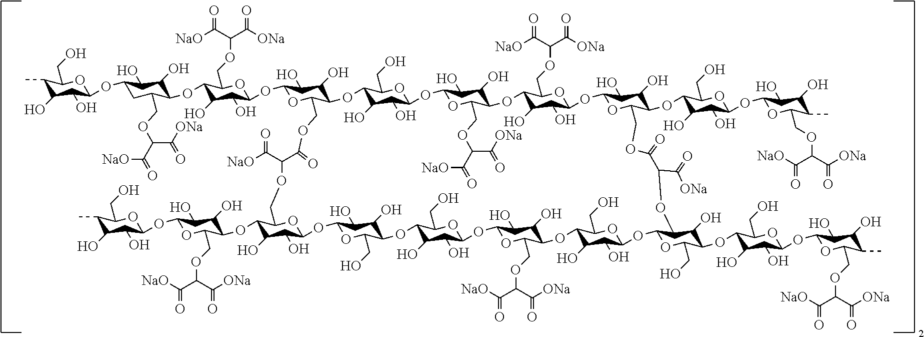
wherein the degree of polymerization is 20, the degree of substitution is 0.5, and the degree of cross-linking is 0.2.

15. (canceled)

16. The compound according to claim 15, wherein the compound is a polymer in the form of a film, or a powder, or a membrane.

17. (canceled)

18. (canceled)

19. (canceled)

20. (canceled)

21. (canceled)

22. A filtration apparatus comprising, a cellulosic membrane, an adsorbent material, or a powder, wherein the film, the cellulosic membrane, the adsorbent material or the powder is defined by the compound recited in claim 1.

23. (canceled)

24. (canceled)

25. A process for producing the compound of formula I recited in claim 1, comprising the following step:
submitting the compound of formula II, [symbol]
wherein
n, R¹, R² and R³ are independently selected from each other,
n is an integer from 20-5000,
R¹, R², R³ are selected from H, Na, K, Ca, Mg, CH(COOH)₂, CH(COONa)₂, CH(COOK)₂, CH(COO)₂Ca, CH(COO)₂Mg,
and at least one R¹ or R² or R³ is CH(COOH)₂, CH(COONa)₂, CH(COOK)₂, CH(COO)₂Ca or CH(COO)₂Mg;
to a cross-link treatment carried out with heat or with epichlorohydrin, epibromohydrin, epiiodohydrin, glutaraldehyde or citric acid.

26. The process according to claim 25, wherein the cross-link treatment is carried out with heat.

27. (canceled)

28. The process according to claim 25, wherein the temperature of the heat is at least 100° C.

29. The process according to claim 28, wherein the temperature of the heat is at least 100° C. for at least 30 minutes.
